(19) United States
(12) Patent Application Publication
(10) Pub. No.: US 2009/0292042 A1
(43) Pub. Date: Nov. 26, 2009

(54) Biodegradable material and plant container

(76) Inventor: Greg S. Patterson, Hopkins, MN (US)

Correspondence Address: Richard C. Emery, Suite G, 3564 Rolling View Drive, White Bear Lake, MN, 55110-7003, US

(21) Appl. No.: 12/154,218

(22) Filed: May 21, 2008

(51) Int. Cl. A01G 9/02; C08K 11/00

(52) U.S. Cl. 523/123; 523/128

(57) ABSTRACT

A biodegradable plant container made from a cellulosically derived polymer is coated with an enhancer to facilitate biodegradation of the container.

### FIELD OF THE INVENTION

The invention relates to biodegradable containers used to store and transport nursery plants during the growth cycle, from grower to retailer to end user.

### BACKGROUND

Each year, millions of plastic nursery plant containers are thrown away and brought to landfill, where they will remain for an extremely long period of time before they degrade into more basic components. In some cases, degradation can take several hundred years. This causes a considerable amount of environmental pollution which is compounded by the sheer numbers of such containers.

The use of paper or fiber based containers for nursery plants is well known in the art. Such planted containers can be directly placed in the ground and will eventually degrade in an acceptable length of time, thus eliminating the pollution issues inherent in plastic nursery containers. Problems exist with paper/fiber based containers, however, in that the paper/fiber material can become soaked with water, which is necessary and always present during plant growth, causing the container to either degrade prematurely or just fall apart, causing the contained plants to become separated from the container and soil and perhaps go to waste. What is clearly needed, then, is a biodegradable nursery plant container that is sturdy enough to house the plant from grower to end user and can be directly planted in the ground without having to remove the plant from the container. A container able to incorporate necessary nutrients to the growing plant would be even more desirable.

### SUMMARY

In one aspect the invention comprises a biodegradable material. The biodegradable material is a substrate which defines a first major surface and a second major surface, with the substrate being made of a polymeric material derived from cellulosic materials. The substrate is in contact with an enhancer to expedite biodegradation of the polymeric material.

In another aspect the invention comprises a biodegradable plant container made from a substrate of a polymeric material derived from cellulosic materials. The plant container defines an inside surface and an outside surface and is capable of containing a volume of a medium capable of supporting plant growth. An enhancer is in contact with the plant container to expedite biodegradation of the polymeric material.

In an alternative aspect, the invention comprises a biodegradable material made from a substrate of a polymeric material derived from cellulosic materials. The substrate defines a first major surface and a second major surface and is made of a polymeric material derived from cellulosic materials, with the substrate mixed with reinforcement. The substrate is in contact with an enhancer to expedite biodegradation of the polymeric material.

In yet another aspect, the invention comprises a biodegradable plant container made from a substrate comprising a polymeric material derived from cellulosic materials, with the substrate mixed with reinforcement. The plant container defines an inside surface and an outside surface and is capable of containing a volume of a medium capable of supporting plant growth. An enhancer is in contact with the plant container to expedite biodegradation of the polymeric material.

In still another aspect, the invention comprises a biodegradable plant container made from a substrate comprising a polymeric material derived from cellulosic materials, with the substrate mixed with reinforcement. The plant container defines an inside surface and an outside surface and is capable of containing a volume of plant growth medium. At least the outer surface of the plant container is three dimensionally inconsistent to provide greater surface area and strength to the container. An enhancer is in contact with the plant container to expedite biodegradation of the polymeric material.

### BRIEF DESCRIPTION OF THE DRAWINGS

FIG. 1 is a cross sectional side view of an embodiment of the biodegradable material of an embodiment of the present invention having a Bacillus containing layer proximate a second major surface of a substrate.

FIG. 2 is a cross sectional side view of an embodiment of the biodegradable material of the present invention having a Bacillus containing layer proximate a first major surface of a substrate.

FIG. 3 is a cross sectional side view of an embodiment of the biodegradable material of the present invention having a Bacillus containing layer proximate a first major surface of a substrate and a Bacillus containing layer proximate a second major surface of a substrate.

FIG. 4 is a side view of a biodegradable plant container of the present invention.

FIG. 4A is a lateral cross section of the plant container of FIG. 4, taken through the lines 4A-4A.

FIG. 5 is a side view of a biodegradable plant container of the present invention.

FIG. 5A is a lateral cross section of the plant container of FIG. 5, taken through the lines 5A-5A.

FIG. 6 is a side view of a biodegradable plant container of the present invention.

FIG. 6A is a lateral cross section of the plant container of FIG. 6, taken through the lines 6A-6A.

FIG. 7 is a cross sectional side view of an embodiment of the biodegradable material of an embodiment of the present invention having separate Bacillus containing and nutrient containing layers proximate a second major surface of a substrate.

FIG. 8 is a cross sectional side view of an embodiment of the biodegradable material of the present invention having a combined Bacillus containing and nutrient containing layer proximate a second major surface of a substrate.

FIG. 9 is a side view of a biodegradable plant container of the present invention.

FIG. 9A is a lateral cross section of the plant container of FIG. 9, taken through the lines 9A-9A.

FIG. 10 is a side view of a biodegradable plant container of the present invention.

FIG. 10A is a lateral cross section of the plant container of FIG. 10, taken through the lines 10A-10A.

FIG. 11 is a cross sectional side view of an embodiment of the biodegradable material of an embodiment of the present invention having a Bacillus containing layer proximate a second major surface of a substrate.

FIG. 12 is a cross sectional side view of an embodiment of the biodegradable material of the present invention having a Bacillus containing layer proximate a first major surface of a substrate.

FIG. 13 is a cross sectional side view of an embodiment of the biodegradable material of the present invention having a Bacillus containing layer proximate a first major surface of a substrate and a Bacillus containing layer proximate a second major surface of a substrate.

FIG. 14 is a side view of a biodegradable plant container of the present invention.

FIG. 14A is a lateral cross section of the plant container of FIG. 14, taken through the lines 14A-14A.

FIG. 15 is a side view of a biodegradable plant container of the present invention.

FIG. 15A is a lateral cross section of the plant container of FIG. 15, taken through the lines 15A-15A.

FIG. 16 is a side view of a biodegradable plant container of the present invention.

FIG. 16A is a lateral cross section of the plant container of FIG. 16, taken through the lines 16A-16A.

FIG. 17 is a cross sectional side view of an embodiment of the biodegradable material of an embodiment of the present invention having separate Bacillus containing and nutrient containing layers proximate a second major surface of a substrate.

FIG. 18 is a cross sectional side view of an embodiment of the biodegradable material of the present invention having a combined Bacillus containing and nutrient containing layer proximate a second major surface of a substrate.

FIG. 19 is a side view of a biodegradable plant container of the present invention.

FIG. 19A is a lateral cross section of the plant container of FIG. 19, taken through the lines 19A-19A.

FIG. 20 is a side view of a biodegradable plant container of the present invention.

FIG. 20A is a lateral cross section of the plant container of FIG. 20, taken through the lines 20A-20A.

FIG. 21 is a side view of a biodegradable plant container of the present invention.

FIG. 21A is a lateral cross section of the plant container of FIG. 21, taken through the lines 21A-21A.

### DETAILED DESCRIPTION

### Definitions

“Bacillus” refers to spore forming bacteria of the family Lactobacillaceae of the order of Eubacteriales.

“Binder” refers to botanically derived materials added to a substrate.

“Biodegradable” refers to a material which, when exposed to bacteria, fungi, ascomycetes, algae, protozoa, other organisms and/or enzymes under ambient temperature or moisture conditions, breaks down to elements found in nature.

“CFU” refers to Colony-forming-Unit, which is a measure of viable bacterial numbers. The results are given as CFU or colony forming units per milliliter.

“Compostable” refers to materials that will eventually biodegrade under simulated composting conditions (e.g., ASTM D5338).

“Enhancer” refers to an organism or substance that facilitates biodegradation of a substrate.

“Lytic Enzymes” refers to a class of enzymes capable of degrading organic material. Examples of lytic enzymes include but are not limited to proteases, lipases, cellulases, amylases and other enzymes capable of degrading acid based carbon chains.

“Nursery Plant Container” or “Plant Container” refers to a container used to store and transport a nursery plant during its growth cycle grower to retailer to end user.

“Nutrients” include but are not limited to inorganic substances such as nitrogen, phosphorus, potassium and other trace minerals used by plants for proper growth.

“Organic Digesting Bacteria” refer to bacteria which degrade organic material. Organic digesting bacteria may be aerobic or anaerobic or facultative. Some organic digesting bacteria may produce lytic enzymes such as proteases, lipases, cellulases, amylases and other enzymes capable of degrading acid based carbon chains.

“Organic Material” refers to but is not limited to materials derived from plant tissue, including but not limited to sawdust, wood shavings, rice hulls, bamboo, hemp, cotton, wood flour, ethanol corn mash and similar materials.

“Polylactide Polymer (PLA)” refers to a natural polymer made of repeating molecular chains of lactic acid which are derived from naturally occurring plant starch materials.

“Reinforcement” means botanically derived material incorporated with substrate which improve the strength of the substrate and also increase the rate of biodegradation.

“Substrate” refers to a cellulose derived polymer upon which an enzyme acts. The enzyme catalyzes chemical reactions involving the substrate. The substrate then can bind with the enzymes and an enzyme substrate complex is formed. Substrate also includes a cellulosic derived polymer mixed with reinforcement added for strength and enhanced biodegradability.

### Nomenclature

10 Biodegradable Material
12 Substrate
14 Enhancer
16 First Major Surface
18 Second Major Surface
20 Binder Layer
22 Nutrients
24 Reinforcement
100 Biodegradable Material
116 First Major Surface
118 Second Major Surface
200 Biodegradable Material
216 First Major Surface
218 Second Major Surface
220a Outer Binder Layer
220b Inner Binder Layer
400 Plant Container
402 Outer Surface
404 Inner Surface
420 Binder Layer
500 Plant Container
502 Outer Surface
504 Inner Surface
520 Binder Layer
600 Plant Container
602 Outer Surface
604 Inner Surface
620a Outer Binder Layer
620b Inner Binder Layer
700 Biodegradable Material
716 First Major Surface
718 Second Major Surface
720a Enhancer Binder Layer
720b Nutrient Binder Layer
800 Biodegradable Material
816 First Major Surface
818 Second Major Surface
820 Binder Layer
900 Plant Container
902 Outer Surface
904 Inner Surface
920a Enhancer Binder Layer
920b Nutrient Binder Layer
1000 Plant Container
1002 Outer Surface
1004 Inner Surface
1020 Binder Layer
1100 Biodegradable Material
1112 Substrate
1116 First Major Surface
1118 Second Major Surface
1120 Binder Layer
1200 Biodegradable Material
1216 First Major Surface
1218 Second Major Surface
1300 Biodegradable Material
1316 First Major Surface
1318 Second Major Surface
1320a Outer Binder Layer
1320b Inner Binder Layer
1400 Plant Container
1402 Outer Surface
1404 Inner Surface
1420 Binder Layer
1500 Plant Container
1502 Outer Surface
1504 Inner Surface
1520 Binder Layer
1600 Plant Container
1602 Outer Surface
1604 Inner Surface
1620a Outer Binder Layer
1620b Inner Binder Layer
1700 Biodegradable Material
1716 First Major Surface
1718 Second Major Surface
1720a Enhancer Binder Layer
1720b Nutrient Binder Layer
1800 Biodegradable Material
1816 First Major Surface
1818 Second Major Surface
1820 Binder Layer
1900 Plant Container
1902 Outer Surface
1904 Inner Surface
1920a Enhancer Binder Layer
1920b Nutrient Binder Layer
2000 Plant Container
2002 Outer Surface
2004 Inner Surface
2020 Binder Layer
2100 Plant Container
2102 Outer Surface
2104 Inner Surface
2114 Rib
2120 Binder Layer
P Plant

### Construction

The particulars shown herein are by way of example and for purposes of illustrative discussion of the invention only and are presented in the cause of providing what is believed to be the most useful and readily understood description of the principles and conceptual aspects of the invention. In this regard, no attempt is made to show structural details of the invention in more detail than is necessary for the fundamental understanding of the invention, the description taken with the drawings making apparent to those skilled in the art how the several forms of the invention may be embodied in practice.

As opposed to plastic or polymeric materials derived from petroleum sources, polylactic acid or PLA is a polymeric material made from naturally occurring organic materials such as dextrose obtained from No. 2 yellow dent field corn and other cellulosic materials. In its virgin state, PLA is classified as being compostable, meaning that it will biodegrade only under simulated composting conditions (ASTM 5338@58 degrees C. (135 degrees F.)). The effect of this is that under typical ambient environmental conditions, PLA is not considered to be biodegradable, due to low oxygen concentration and temperature which retard molecular weight loss. As an example, when placed into a landfill, PLA at typical subsurface temperatures (3 to 4 feet below surface and intermediate humidity), would take decades before the polymer would degrade to even its half life of 40,000 molecular weight. When PLA is contacted by an enhancer 14, however, the biodegradation rate increases dramatically due to enzymatic oxidation of the PLA, which varies due to environmental conditions such as heat and moisture content present in the soil.

The enhancer 14 can be any organism or enzyme that facilitates the biodegradation of the substrate 12, including fungal spores (Mycorrhizal fungi, Aspergillis, Trichoderma, Humicola, Neocallimastix), bacteria (Bacillus families), and enzymes (any number of thousands capable of catalyzing short carbon chains, which provide initial oxidation of the container).

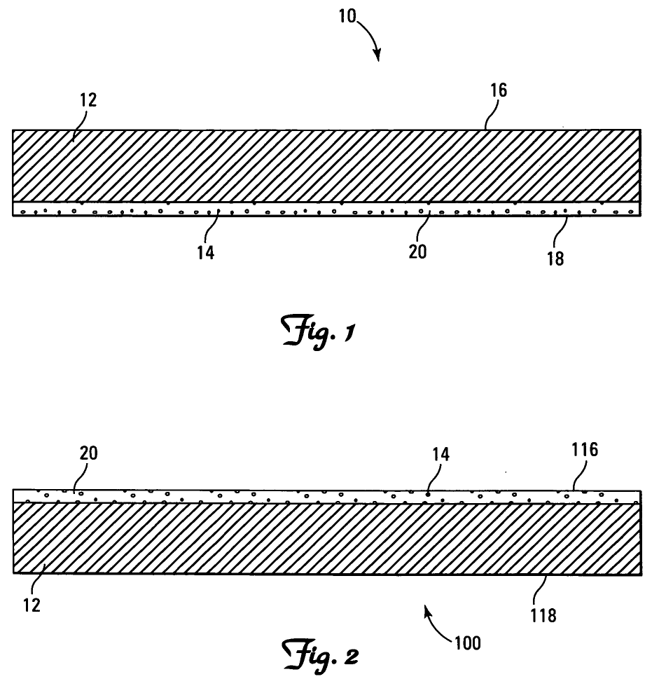

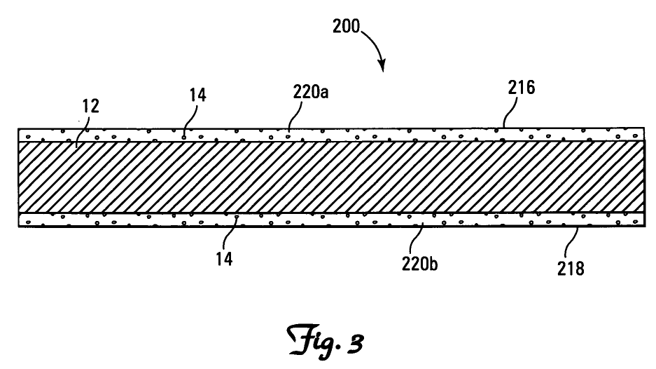

FIG. 1 is a cross sectional side view of an embodiment of a biodegradable material 10 which can be used to make plant containers 400, 500, 600, 900, 1000 and other vessels that will safely biodegrade under ambient temperature and moisture conditions. It is seen in FIG. 1 that the substrate 12 is coated with an enhancer 14 used to facilitate the biodegradation of the substrate 12 under the proper conditions, as discussed in detail below. The substrate 12 is made from a cellulosic derived polymer such as PLA and it is contemplated by and therefore within the scope of the invention to have the substrate 12 comprise pure PLA or PLA combined with a botanically derived structural reinforcement 24 such as wood shavings, rice hulls, wheat hulls, dried cow manure, dried poultry manure, hemp, cotton, ethanol mash and other similar substances. PLA in its virgin state has a melting temperature between 145 degrees C. to 220 degrees C. depending on the particular variety of PLA.

In one embodiment, the enhancer can be bacteria from the genus bacillus, which can be present at a rate of 100,000 to 5,000,000,000 CFU per milliliter. In another embodiment, the enhancer 14 can be lytic enzymes or a blend of enzymes similar to those sold by Great Lakes Bio Systems, Inc. (GLB). The enhancer 14 is affixed to a second major surface 16 of the substrate 12 by a binder layer 20 such as a propylene glycol water solution.

Shown in FIG. 2 is another embodiment of the biodegradable material 100 which is similar to the biodegradable material 10 and differs in having the enhancer 14 affixed by a binder layer 20 to the first major surface 116 of the substrate 12. Yet another embodiment of the biodegradable material 200 is shown in FIG. 3 and differs from the embodiments 10 and 100 by having the enhancer 14 affixed by an outer binder layer 220a to a first major surface 216 and by an inner binder layer 220b to a second major surface 218.

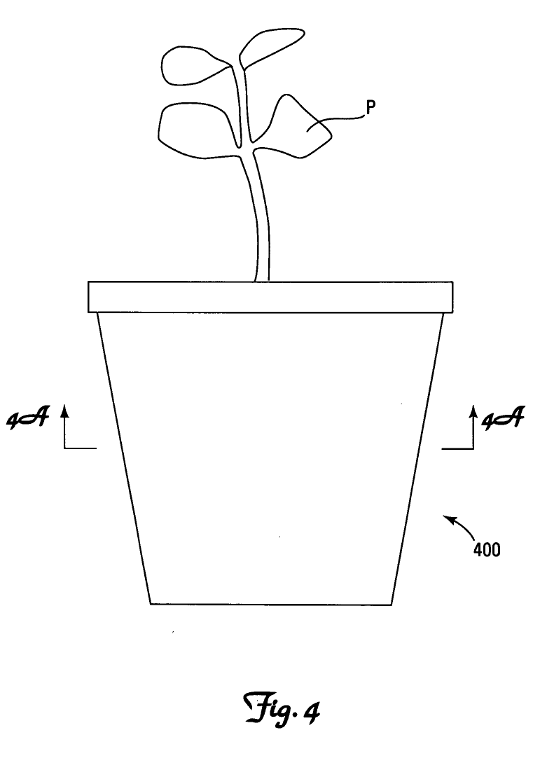

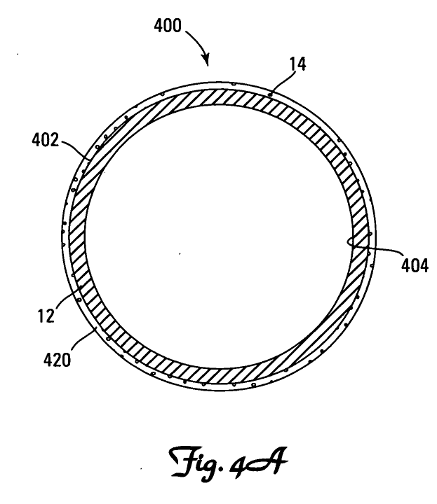

FIG. 4 is a side view of a biodegradable plant container 400 of the present invention, which is conventional in appearance and is used to contain a plant P during the growth process and transportation to an end user. FIG. 4A is a lateral cross section of the plant container of FIG. 4, taken through the lines 4A-4A as shown in FIG. 4. It is seen that the substrate 12 is coated on an outer surface 402 by a binder layer 420 containing enhancer 14. Following being planted with a live plant, the biodegradable plant container 400 is planted in the ground and eventually subjected to the specific temperature and moisture conditions under which the plant container 400 is programmed to biodegrade. Because the plant container 400 is programmed to biodegrade in a relatively short time period following exposure to the appropriate temperature and moisture conditions, it is unnecessary to remove the plant P before planting. The plant container 400 instead breaks down into more basic components, which will harmlessly leach away with time and/or combine with the soil.

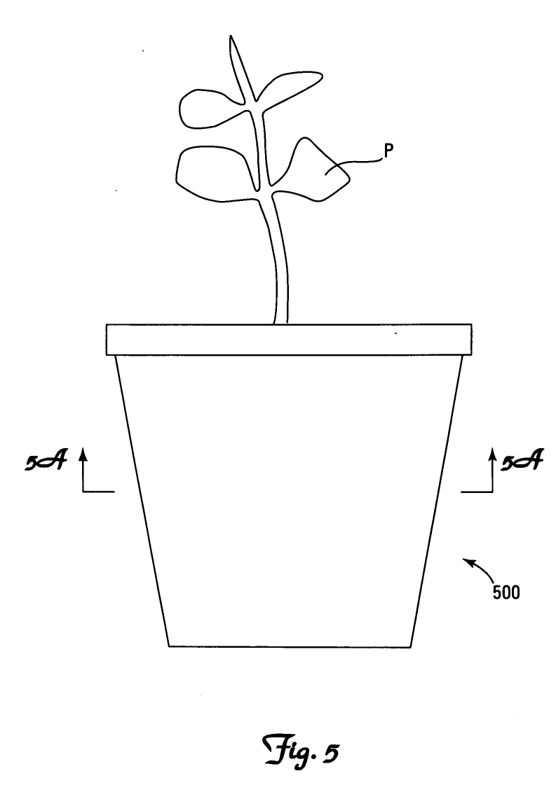

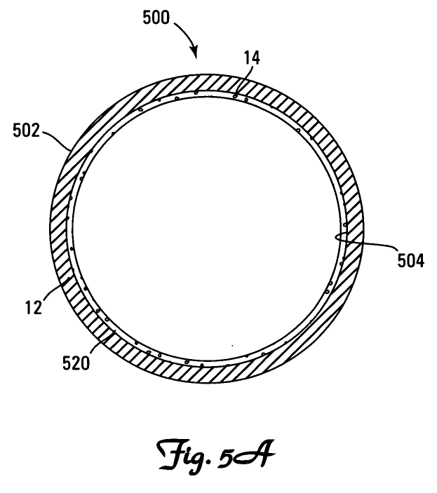

FIG. 5 is a side view of a biodegradable plant container 500 of the present invention, which is conventional in appearance and is used to contain a plant P during the growth process and transportation to an end user. FIG. 5A is a lateral cross section of the plant container of FIG. 5, taken through the lines 5A-5A as shown in FIG. 5. It is seen that the substrate 12 is coated on an inner surface 504 by a binder layer 520 containing enhancer 14. Following being planted with a live plant, the biodegradable plant container 500 is planted in the ground and eventually subjected to the specific temperature and moisture conditions under which the plant container 500 is programmed to biodegrade. Because the plant container 500 is programmed to biodegrade in a relatively short time period following exposure to the appropriate temperature and moisture conditions, it is unnecessary to remove the plant P before planting. The plant container 500 instead breaks down into more basic components, which will harmlessly leach away with time and/or combine with the soil.

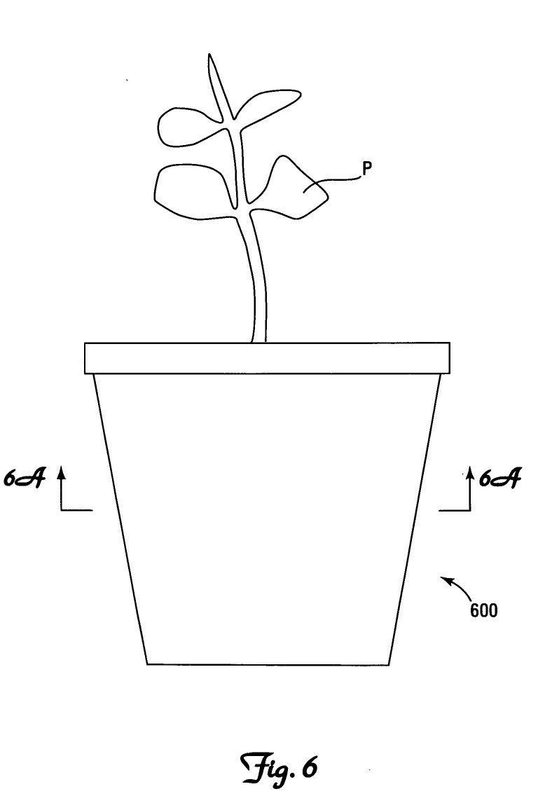

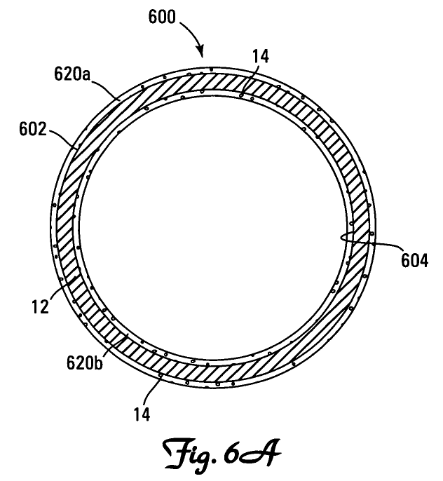

FIG. 6 is a side view of a biodegradable plant container 600 of the present invention, which is conventional in appearance and is used to contain a plant P during the growth process and transportation to an end user. FIG. 6A is a lateral cross section of the plant container of FIG. 6, taken through the lines 6A-6A as shown in FIG. 6. It is seen that the substrate 12 is coated on an inner surface 604 by an inner binder layer 620b containing enhancer 14. It is further seen in FIG. 6A that the substrate 12 is also coated on an outer surface 602 by an outer binder layer 620a containing enhancer. Following being planted with a live plant, the biodegradable plant container 600 is planted in the ground and eventually subjected to the specific temperature and moisture conditions under which the plant container 600 is programmed to biodegrade. Because the plant container 600 is programmed to biodegrade in a relatively short time period following exposure to the appropriate temperature and moisture conditions, it is unnecessary to remove the plant P before planting. The plant container 600 instead breaks down into more basic components, which will harmlessly leach away with time and/or combine with the soil.

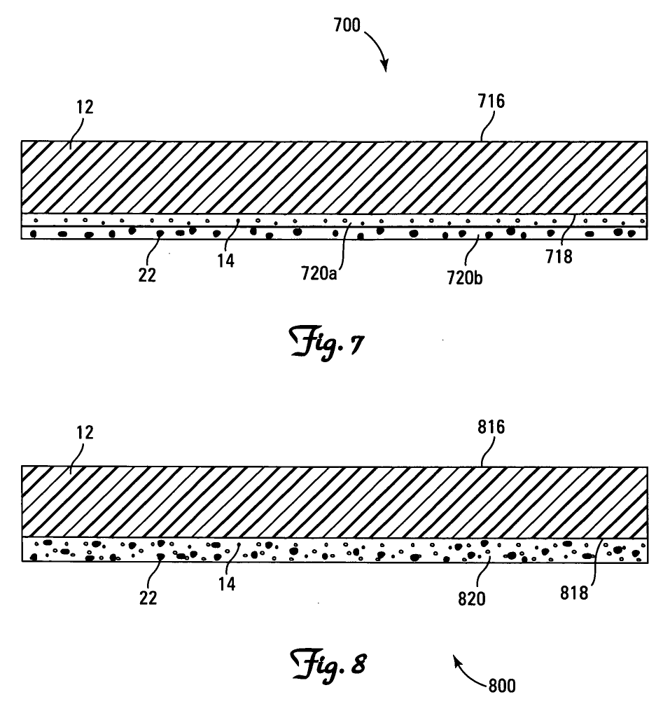

FIG. 7 is a cross sectional side view of an embodiment of a biodegradable material 700 which can be used to make plant containers and other vessels that will safely biodegrade under ambient temperature and moisture conditions. It is seen in FIG. 7 that the substrate 12 contains an enhancer binder layer 720a which binds enhancer 14. An additional nutrient binder layer 720b contains nutrients 22 and is separate from the enhancer binder layer 720a. The nutrients 22 are required for plant growth and may include nitrogen, phosphorus, potassium and other micronutrients including but not limited to iron, boron, manganese, zinc, copper, molybdenum and chlorine as needed for particular applications. As shown in FIG. 7, the enhancer binder layer 720a is shown as being proximate a second major surface 718 of the substrate 12 and the nutrient binder layer 720b is shown as directly contacting the outer surface (unnumbered) of the enhancer binder layer 720a. This is for purposes of illustration only and the invention contemplates and therefore is within the scope of the reverse (not shown), i.e., the nutrient binder layer 720b directly contacts the second major surface 718 of the substrate 12 and the enhancer binder layer 720a directly contacts nutrient binder layer 720b. The enhancer binder layer 720a and nutrient binder layer 720b can be a substance such as a propylene glycol water solution. The specific concentration of enhancer 14 and nutrients 22 is different for each application based on variables.

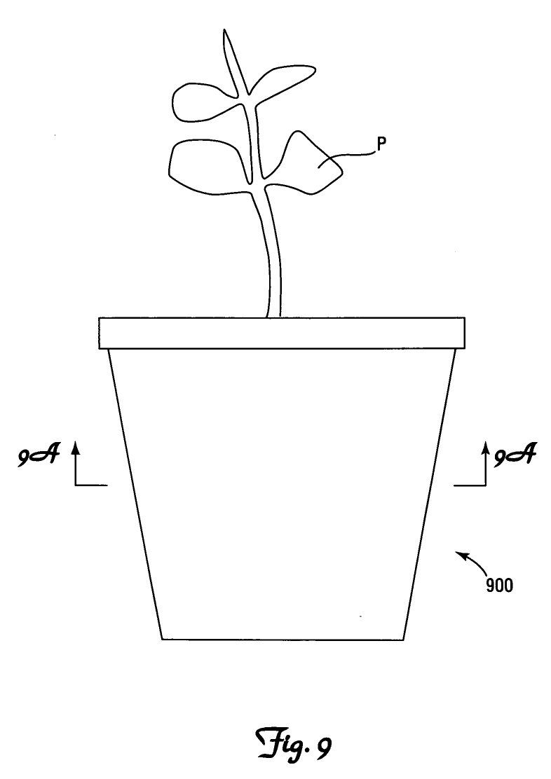

Shown in FIG. 8 is an embodiment of a biodegradable material 800 which is similar to the biodegradable material 700 and differs in having the enhancer 14 and nutrients 22 affixed to the second major surface 818 of the substrate 12 by a single binder layer 820.

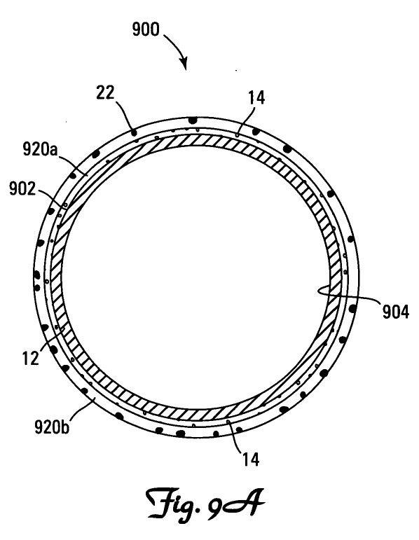

FIG. 9 is a side view of a biodegradable plant container 900 of the present invention, which is conventional in appearance and is used to contain a plant P during the growth process and transportation to an end user. FIG. 9A is a lateral cross section of the plant container of FIG. 9, taken through the lines 9A-9A as shown in FIG. 9. It is seen that the substrate 12 is coated on an outer surface 902 by an enhancer binder layer 920a containing enhancer 14. A nutrient binder layer 920b contains nutrients 22 as required for plant growth and is proximate to and separate from the enhancer binder layer 920a. The nutrients 22 are required for plant growth and may include nitrogen, phosphorus, potassium and other micronutrients including but not limited to iron, boron, manganese, zinc, copper, molybdenum and chlorine. As shown in FIG. 9A, the enhancer binder layer 920a is shown as being proximate the outer surface 902 of the substrate 12 and directly contacts the inner surface (unnumbered) of the nutrient binder layer 920b. This is for purposes of illustration only and the invention contemplates and is therefore within the scope of the reverse (not shown), i.e., the nutrient binder layer 920b directly contacts the second major surface 918 of the substrate 12 and the enhancer binder layer 920a directly contacts nutrient binder layer 920b. Following being planted with a live plant, the biodegradable plant container 900 is planted in the ground and eventually subjected to the specific temperature and moisture conditions under which the plant container 900 is programmed to biodegrade. Because the plant container 900 is programmed to biodegrade in a relatively short time period following exposure to the appropriate temperature and moisture conditions, it is unnecessary to remove the plant P before planting. The plant container 900 instead breaks down into more basic components, which will harmlessly leach away with time and/or combine with the soil. The nutrients 22 will remain behind and eventually be taken up by the plant P as it grows.

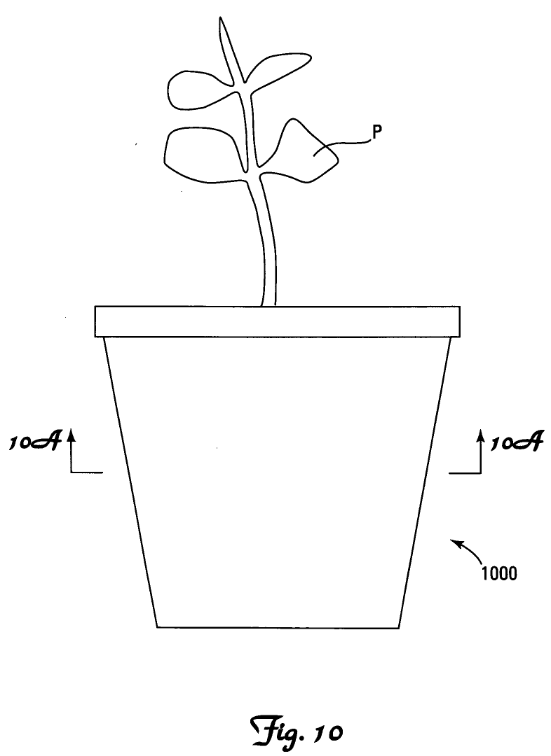

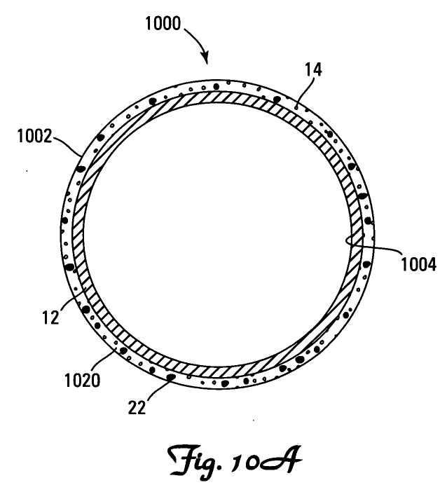

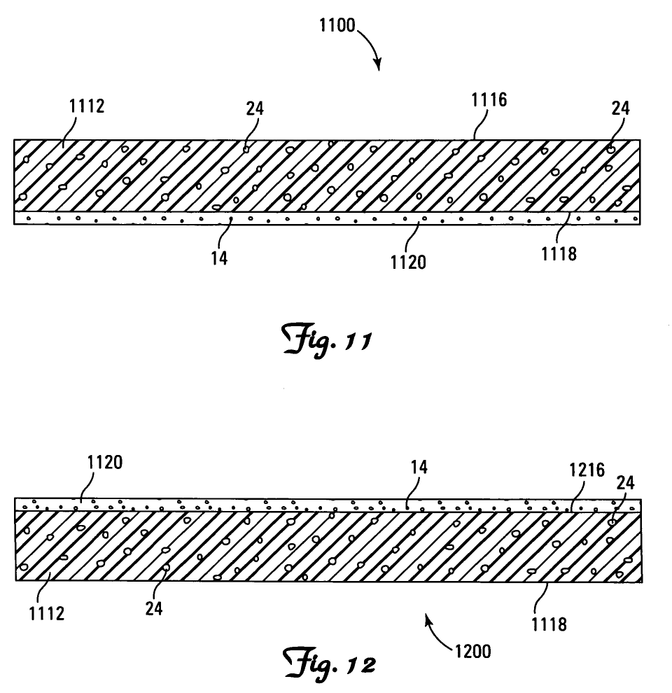

FIG. 10 is a side view of a biodegradable plant container 1000 of the present invention, which is conventional in appearance and is used to contain a plant P during the growth process and transportation to an end user. FIG. 10A is a lateral cross section of the plant container of FIG. 10, taken through the lines 10A-10A as shown in FIG. 10. It is seen that the substrate 12 is coated on an outer surface 1002 by a binder layer 1020 containing a mixture of enhancer 14 and nutrients 22. The nutrients 22 are required for plant growth and may include nitrogen, phosphorus, potassium and other micronutrients including but not limited to iron, boron, manganese, zinc, copper, molybdenum and chlorine as needed for particular applications. Following being planted with a live plant, the biodegradable plant container 1000 is planted in the ground and eventually subjected to the specific temperature and moisture conditions under which the plant container 1000 is programmed to biodegrade. Because the plant container 1000 is programmed to biodegrade in a relatively short time period following exposure to the appropriate temperature and moisture conditions, it is unnecessary to remove the plant P before planting. The plant container 1000 instead breaks down into more basic components, which will harmlessly leach away with time and/or combine with the soil. The nutrients 22 will remain behind and eventually be taken up by the plant P as it grows.

FIG. 11 is a cross sectional side view of an embodiment of a biodegradable material 1100 which can be used to make plant containers 1400, 1500, 1600, 1900, 2000, 2100 and other vessels that will safely biodegrade under ambient temperature and moisture conditions. It is seen in FIG. 11 that the substrate 1112 is coated on a second major surface 1118 with an enhancer 14 used to facilitate the biodegradation of the substrate 1112 under the proper conditions. The substrate 1112 is made from a cellulosic derived polymer such as PLA. The substrate 1112 comprises PLA filled with a botanically derived structural reinforcement 24 such as wood shavings, rice hulls, wheat hulls, dried cow manure, dried poultry manure, hemp, cotton, ethanol mash and other similar substances. The PLA has a melting temperature between 145 degrees C. to 220 degrees C. depending on the particular variety of PLA.

In one embodiment, the enhancer can be bacteria from the genus bacillus, which can be present at a rate of 100,000 to 5,000,000,000 CFU per milliliter. In another embodiment, the enhancer 14 can be lytic enzymes or a blend of enzymes similar to those sold by Great Lakes Bio Systems, Inc. (GLB). The enhancer 14 is affixed to a second major surface 1118 of the substrate 1112 by a binder layer 20 such as a propylene glycol water solution.

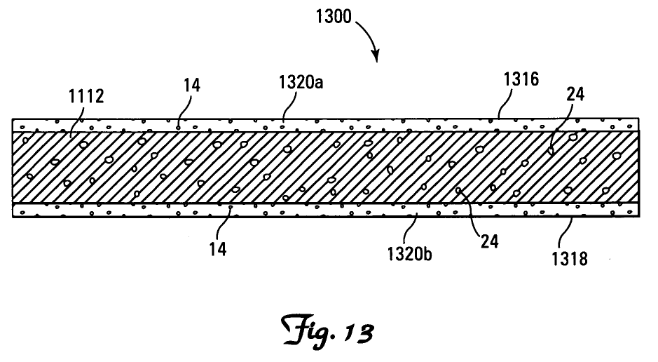

Shown in FIG. 12 is another embodiment of a biodegradable material 1200 which is similar to the biodegradable material 1100 and differs in having the enhancer 14 affixed by a binder layer 20 to a first major surface 1216 of the substrate 1112. Yet another embodiment of a biodegradable material 1300 is shown in FIG. 13 and differs from the embodiments 1100 and 1200 by having the enhancer 14 affixed by an outer binder layer 1220a to a first major surface 1216 and by an inner binder layer 1220b to a second major surface 1218.

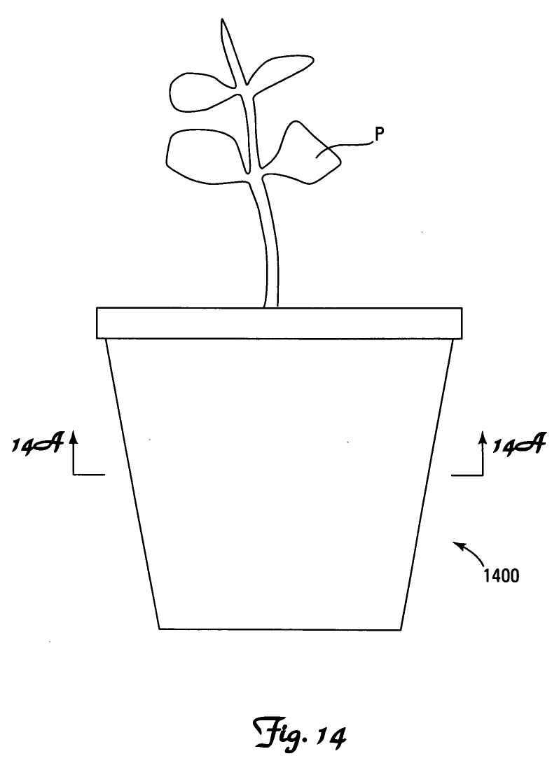

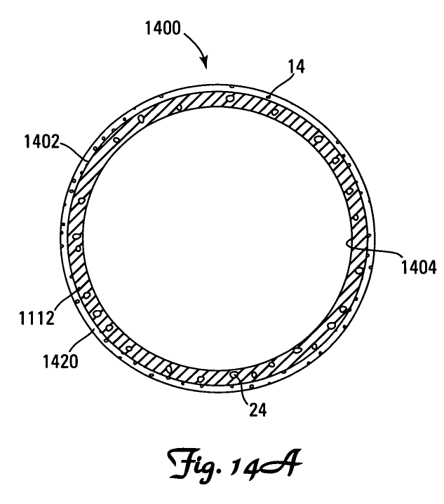

FIG. 14 is a side view of a biodegradable plant container 1400 of the present invention, which is conventional in appearance and is used to contain a plant P during the growth process and transportation to an end user. FIG. 14A is a lateral cross section of the plant container of FIG. 14, taken through the lines 14A-14A as shown in FIG. 14. It is seen that the substrate 1112 is coated on an outer surface 1402 by a binder layer 1420 containing enhancer 14. Following being planted with a live plant, the biodegradable plant container 1400 is planted in the ground and eventually subjected to the specific temperature and moisture conditions under which the plant container 1400 is programmed to biodegrade. Because the plant container 1400 is programmed to biodegrade in a relatively short time period following exposure to the appropriate temperature and moisture conditions, it is unnecessary to remove the plant P before planting. The plant container 1400 instead breaks down into more basic components, which will harmlessly leach away with time and/or combine with the soil. The nutrients 22 will remain behind and eventually be taken up by the plant P as it grows.

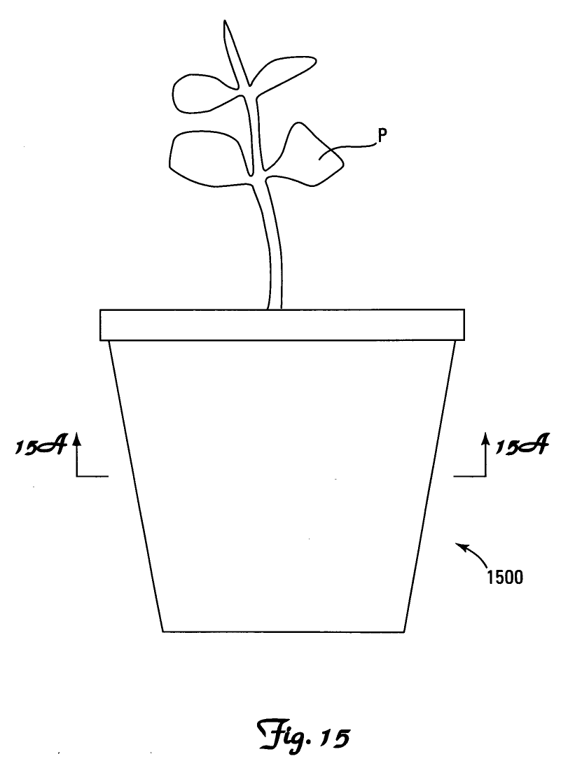

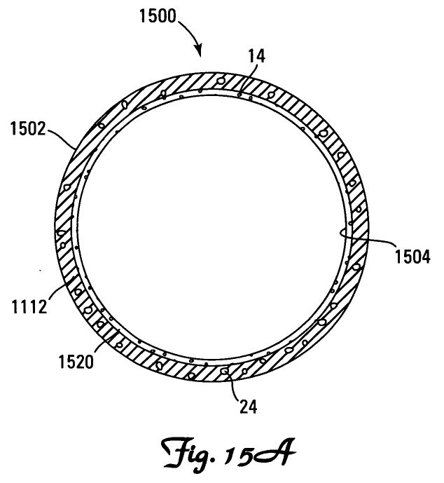

FIG. 15 is a side view of a biodegradable plant container 1500 of the present invention, which is conventional in appearance and is used to contain a plant P during the growth process and transportation to an end user. FIG. 15A is a lateral cross section of the plant container of FIG. 15, taken through the lines 15A-15A as shown in FIG. 15. It is seen that the substrate 1112 is coated on an inner surface 1504 by a binder layer 1520 containing enhancer 14. Following being planted with a live plant, the biodegradable plant container 1500 is planted in the ground and eventually subjected to the specific temperature and moisture conditions under which the plant container 1500 is programmed to biodegrade. Because the plant container 1500 is programmed to biodegrade in a relatively short time period following exposure to the appropriate temperature and moisture conditions, it is unnecessary to remove the plant P before planting. The plant container 1500 instead breaks down into more basic components, which will harmlessly leach away with time and/or combine with the soil.

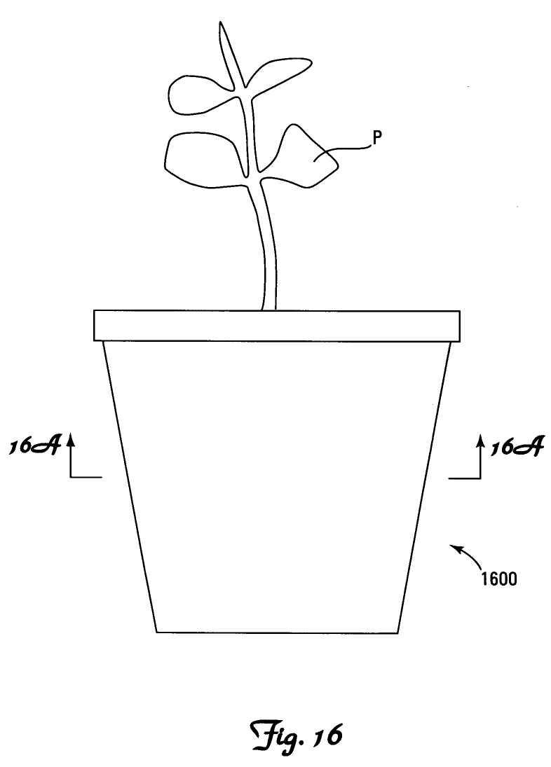

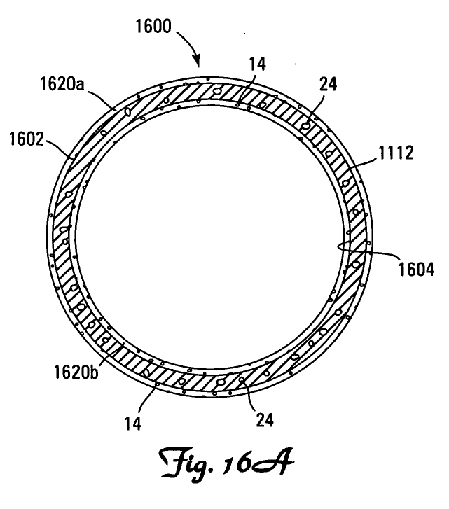

FIG. 16 is a side view of a biodegradable plant container 1600 of the present invention, which is conventional in appearance and is used to contain a plant P during the growth process and transportation to an end user. FIG. 16A is a lateral cross section of the plant container of FIG. 16, taken through the lines 16A-16A as shown in FIG. 16. It is seen that the substrate 1112 is coated on an inner surface 1604 by an inner binder layer 1620b containing enhancer 14. It is further seen in FIG. 16A that the substrate 1112 is also coated on an outer surface 1602 by an outer binder layer 1620a containing enhancer. Following being planted with a live plant, the biodegradable plant container 1600 is planted in the ground and eventually subjected to the specific temperature and moisture conditions under which the plant container 1600 is programmed to biodegrade. Because the plant container 1600 is programmed to biodegrade in a relatively short time period following exposure to the appropriate temperature and moisture conditions, it is unnecessary to remove the plant P before planting. The plant container 1600 instead breaks down into more basic components, which will harmlessly leach away with time and/or combine with the soil.

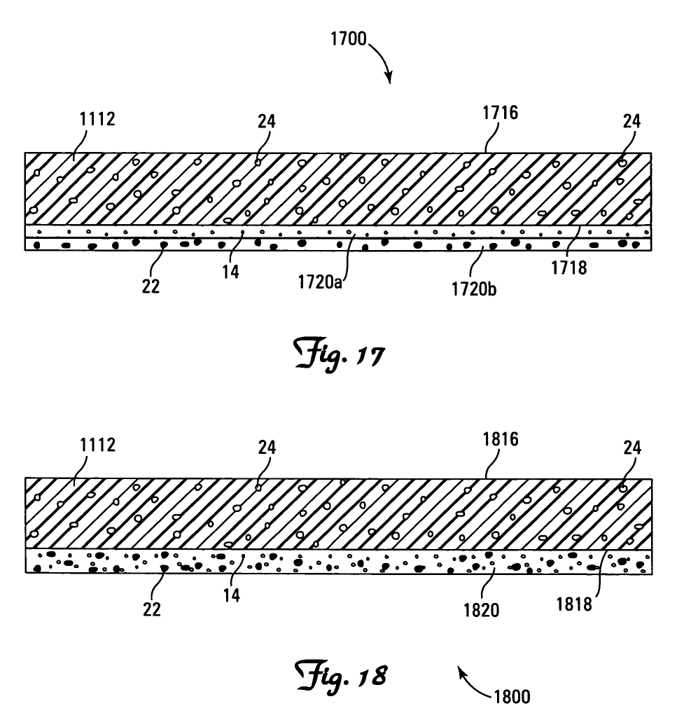

FIG. 17 is a cross sectional side view of an embodiment of a biodegradable material 1700 which can be used to make plant containers and other vessels that will safely biodegrade under ambient temperature and moisture conditions. It is seen in FIG. 17 that the substrate 1112 contains an enhancer binder layer 1720a which binds enhancer 14. An additional nutrient binder layer 1720b contains nutrients 22 and is proximate to but separate from the enhancer binder layer 1720a. The nutrients 22 are required for plant growth and may include nitrogen, phosphorus, potassium and other micronutrients including but not limited to iron, boron, manganese, zinc, copper, molybdenum and chlorine as needed for particular applications. As shown in FIG. 17, the enhancer binder layer 1720a is shown as being proximate a second major surface 1718 of the substrate 12 and the nutrient binder layer 1720b is shown as directly contacting the outer surface (unnumbered) of the enhancer binder layer 1720a. This is for purposes of illustration only and the invention contemplates and therefore is within the scope of the reverse (not shown), i.e., the nutrient binder layer 1720b directly contacts the second major surface 1718 of the substrate 1112 and the enhancer binder layer 1720a directly contacts nutrient binder layer 1720b. The enhancer binder layer 1720a and nutrient binder layer 1720b can be a substance such as a propylene glycol water solution. The specific concentration of enhancer 14 and nutrients 22 is different for each application based on variables.

Shown in FIG. 18 is an embodiment of a biodegradable material 1800 which is similar to the biodegradable material 1700 and differs in having the enhancer 14 and nutrients 22 affixed to the second major surface 1818 of the substrate 12 by a single binder layer 1820.

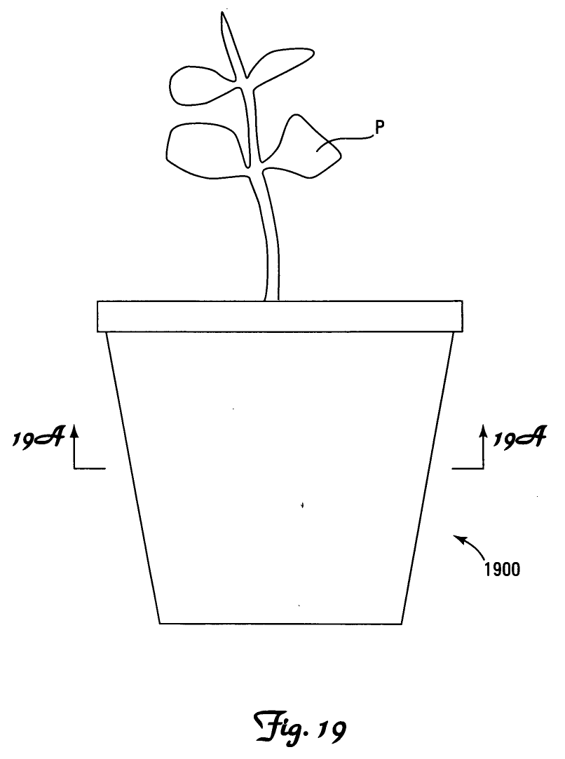

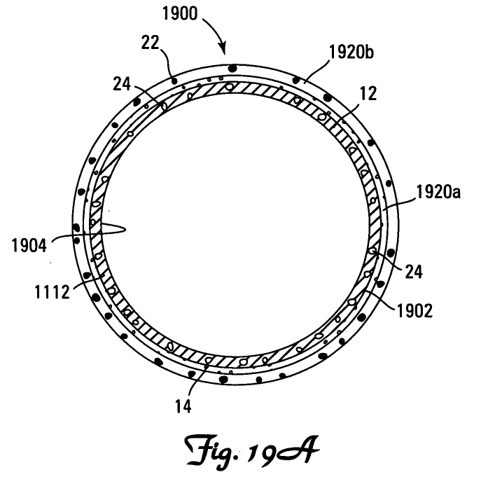

FIG. 19 is a side view of a biodegradable plant container 1900 of the present invention, which is conventional in appearance and is used to contain a plant P during the growth process and transportation to an end user. FIG. 19A is a lateral cross section of the plant container of FIG. 19, taken through the lines 19A-19A as shown in FIG. 19. It is seen that the substrate 1112 is coated on an outer surface 1902 by an enhancer binder layer 1920a containing enhancer 14. A nutrient binder layer 1920b contains nutrients 22 as required for plant growth and is proximate to and separate from the enhancer binder layer 1920a. The nutrients 22 are required for plant growth and may include nitrogen, phosphorus, potassium and other micronutrients including but not limited to iron, boron, manganese, zinc, copper, molybdenum and chlorine or as needed for a particular application. As shown in FIG. 19A, the enhancer binder layer 1920a is shown as being proximate the outer surface 1902 of the substrate 1112 and directly contacts the inner surface (unnumbered) of the nutrient binder layer 1920b. This is for purposes of illustration only and the invention contemplates and is therefore within the scope of the reverse (not shown), i.e., the nutrient binder layer 1920b directly contacts the second major surface 1918 of the substrate 1112 and the enhancer binder layer 1920a directly contacts the inner surface of the enhancer binder layer 1920a. Following being planted with a live plant, the biodegradable plant container 1900 is planted in the ground and eventually subjected to the specific temperature and moisture conditions under which the plant container 1900 is programmed to biodegrade. Because the plant container 1900 is programmed to biodegrade in a relatively short time period following exposure to the appropriate temperature and moisture conditions, it is unnecessary to remove the plant P before planting. The plant container 1900 instead breaks down into more basic components, which will harmlessly leach away with time and/or combine with the soil. The nutrients 22 will remain behind and eventually be taken up by the plant P as it grows.

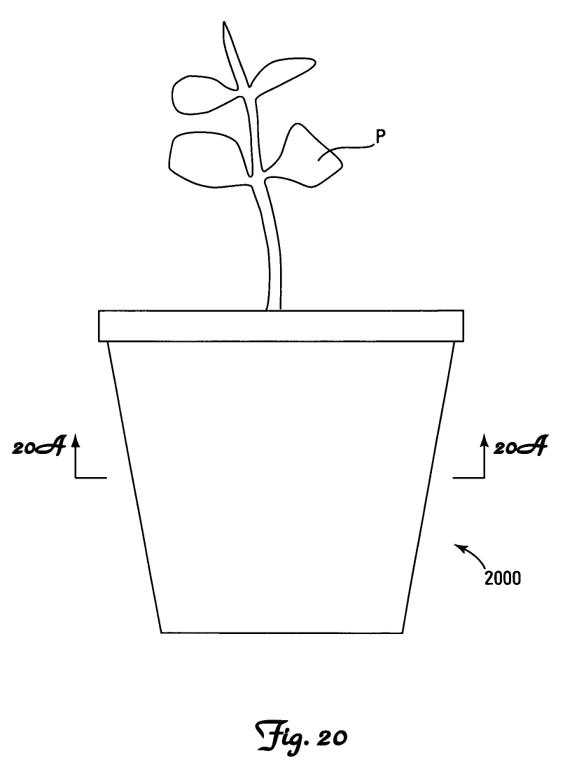

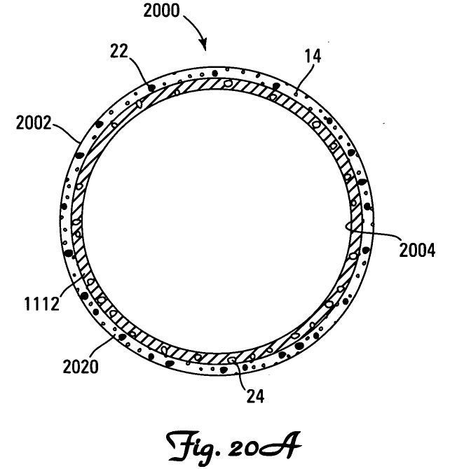

FIG. 20 is a side view of a biodegradable plant container 2000 of the present invention, which is conventional in appearance and is used to contain a plant P during the growth process and transportation to an end user. FIG. 20A is a lateral cross section of the plant container of FIG. 20, taken through the lines 20A-20A as shown in FIG. 20. It is seen that the substrate 1112 is coated on an outer surface 2002 by a binder layer 2020 containing a mixture of enhancer 14 and nutrients 22. The nutrients 22 are required for plant growth and may include nitrogen, phosphorus, potassium and other micronutrients including but not limited to iron, boron, manganese, zinc, copper, molybdenum and chlorine as needed for particular applications. Following being planted with a live plant, the biodegradable plant container 2000 is planted in the ground and eventually subjected to the specific temperature and moisture conditions under which the plant container 2000 is programmed to biodegrade. Because the plant container 2000 is programmed to biodegrade in a relatively short time period following exposure to the appropriate temperature and moisture conditions, it is unnecessary to remove the plant P before planting. The plant container 2000 instead breaks down into more basic components, which will harmlessly leach away with time and/or combine with the soil. The nutrients 22 will remain behind and eventually be taken up by the plant P as it grows.

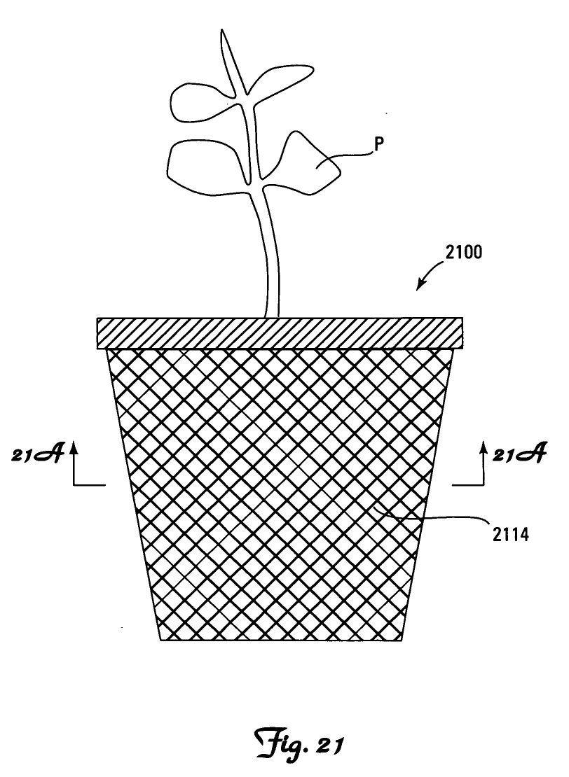

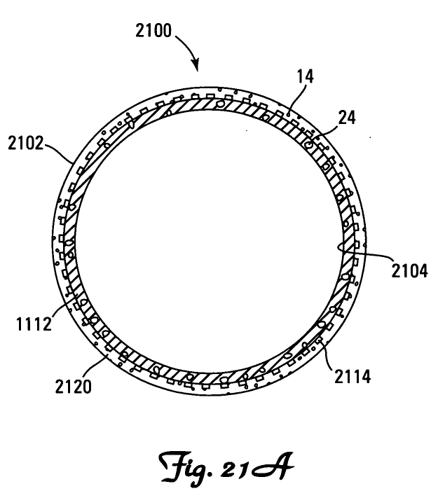

FIG. 21 is a side view of a biodegradable plant container 2100 of the present invention, which is used to contain a plant P during the growth process and transportation to an end user. FIG. 21A is a lateral cross section of the plant container of FIG. 21, taken through the lines 21A-21A as shown in FIG. 21. It is seen that the substrate 1112 is coated on an outer surface 2102 by a binder layer 2120 containing a mixture of enhancer 14 and nutrients 22. The nutrients 22 are required for plant growth and may include nitrogen, phosphorus, potassium and other micronutrients including but not limited to iron, boron, manganese, zinc, copper, molybdenum and chlorine as needed for particular applications. It will be noticed that the outer surface 2102 is configured with a series of interconnecting ribs 2114 which serve two purposes. The ribs 2114 act to greatly strengthen the plant container 2100 allowing a lighter container to be made using less substrate 1112. Further, the ribs 2114 also increase the amount of surface area which allows a greater concentration of the enhancer/nutrient mixture to be applied, thus providing a plant container 2100 that will biodegrade faster but also a higher concentration of nutrients 22 to facilitate early plant P growth following biodegradation of the substrate 1112. The invention contemplates additional three dimensional surface variations such as a “honeycomb” configuration (not shown) which would confer similar advantages as a ribbed surface configuration. Following being planted with a live plant, the biodegradable plant container 2100 is planted in the ground and eventually subjected to the specific temperature and moisture conditions under which the plant container 2100 is programmed to biodegrade. Because the plant container 2100 is programmed to biodegrade in a relatively short time period following exposure to the appropriate temperature and moisture conditions, it is unnecessary to remove the plant P before planting. The plant container 2100 instead breaks down into more basic components, which will harmlessly leach away with time and/or combine with the soil. The nutrients 22 will remain behind and eventually be taken up by the plant P as it grows.

What is claimed is:

1. A biodegradable material, comprising:
a substrate defining a first major surface and a second major surface, the substrate being made of a polymeric material derived from cellulosic materials, the substrate being in contact with an enhancer to expedite biodegradation of the polymeric material.

2. The biodegradable material of claim 1 wherein the substrate is coated on both the first major surface and second major surface with enhancer.

3. The biodegradable material of claim 2 wherein the enhancer is affixed to the substrate by a binder layer.

4. The biodegradable material of claim 3 wherein the binder layer is a mixture of propylene glycol and water.

5. The biodegradable material of claim 1 wherein the substrate is PLA.

6. The biodegradable material of claim 1 wherein the substrate is coated with nutrients.

7. A biodegradable plant container, comprising:
an inside surface and an outside surface, the container capable of containing a volume of a medium capable of supporting plant growth, the plant container being made of a substrate comprising a polymeric material derived from cellulosic materials;
wherein the plant container is in contact with an enhancer to expedite biodegradation of the polymeric material.

8. The plant container of claim 7 wherein the plant container is coated on the outside surface with the enhancer.

9. The plant container of claim 7 wherein the plant container is coated on the inside surface with the enhancer.

10. The plant container of claim 7 wherein the plant container is coated on both the outside surface and the inside surface with the enhancer.

11. The plant container of claim 7 wherein the enhancer is affixed to the plant container by a binder layer.

12. The plant container of claim 11 wherein the binder layer is a mixture of propylene glycol and water.

13. The plant container of claim 7 wherein the substrate is PLA.

14. The plant container of claim 7 wherein the substrate is coated with nutrients.

15. The plant container of claim 14 wherein the enhancer and nutrients are coated in separate layers.

16. The plant container of claim 14 wherein the enhancer and nutrients are coated in a common layer.

17. A biodegradable material, comprising:
a substrate defining a first major surface and a second major surface, the substrate being made of a polymeric material derived from cellulosic materials, the substrate being mixed with reinforcement, the substrate being in contact with an enhancer to expedite biodegradation of the polymeric material.

18. The biodegradable material of claim 17 wherein the substrate is coated on both the first major surface and second major surface with enhancer.

19. The biodegradable material of claim 18 wherein the enhancer is affixed to the substrate by a binder layer.

20. The biodegradable material of claim 19 wherein the binder layer is a mixture of propylene glycol and water.

21. The biodegradable material of claim 17 wherein the substrate is PLA.

22. The biodegradable material of claim 17 wherein the substrate is coated with nutrients.

23. A biodegradable plant container, comprising:
an inside surface and an outside surface, the container capable of containing a volume of a medium capable of supporting plant growth, the plant container being made of a substrate comprising a polymeric material derived from cellulosic materials, the substrate being mixed with reinforcement;
wherein the plant container is in contact with an enhancer to expedite biodegradation of the polymeric material.

24. The plant container of claim 23 wherein the plant container is coated on the outside surface with the enhancer.

25. The plant container of claim 23 wherein the plant container is coated on the inside surface with the enhancer.

26. The plant container of claim 23 wherein the plant container is coated on both the outside surface and the inside surface with the enhancer.

27. The plant container of claim 23 wherein the enhancer is affixed to the plant container by a binder layer.

28. The plant container of claim 27 wherein the binder layer is a mixture of propylene glycol and water.

29. The plant container of claim 23 wherein the substrate is PLA.

30. The plant container of claim 23 wherein the substrate is coated with nutrients.

31. The plant container of claim 30 wherein the enhancer and nutrients are coated in separate layers.

32. The plant container of claim 30 wherein the enhancer and nutrients are coated in a common layer.

33. A biodegradable plant container, comprising:
an inside surface and an outside surface, the container capable of containing a volume of plant growth medium, the plant container being made of a substrate comprising a polymeric material derived from cellulosic materials, the substrate containing reinforcement, at least the outer surface is three dimensionally inconsistent to provide greater surface area and strength to the container;
wherein the plant container is in contact with an enhancer to expedite biodegradation of the polymeric material.

34. The plant container of claim 33 wherein at least the outer surface is configured with a plurality of ribs.
